(19) United States
(12) Patent Application Publication
(10) Pub. No.: US 2026/0036315 A1
(43) Pub. Date: Feb. 5, 2026

(54) PTC HEATER FOR AN HVAC SYSTEM

(71) Applicants: HYUNDAI MOTOR COMPANY, Seoul (KR); KIA CORPORATION, Seoul (KR); AJIN INDUSTRIAL CO., LTD., Gyeongsan-si (KR)

(72) Inventors: Myung Jun Kim, Hwaseong-si (KR); Sang Yeop Lee, Hwaseong-si (KR); Young Su Nam, Hwaseong-si (KR); Kyeong Min Kang, Hwaseong-si (KR); Dong Won Yeon, Hwaseong-si (KR); Tae Kun Kim, Hwaseong-si (KR); Dong Hyeop Kim, Hwaseong-si (KR); Ju Yong Jang, Daegu (KR); Sung Yeob Park, Gyeongsan-si (KR); Soo Young Ha, Daegu (KR)

(73) Assignees: HYUNDAI MOTOR COMPANY, Seoul (KR); KIA CORPORATION, Seoul (KR); AJIN INDUSTRIAL CO., LTD., Gyeongsan-si (KR)

(21) Appl. No.: 18/970,631

(22) Filed: Dec. 5, 2024

(30) Foreign Application Priority Data
Aug. 5, 2024 (KR) 10-2024-0103865

(51) Int. Cl. F24F 11/30; H05B 3/42

(52) U.S. Cl. CPC F24F 11/30; H05B 3/42; H05B 2203/02

(57) ABSTRACT

A positive temperature coefficient (PTC) heater for a heating, ventilation, and air conditioning (HVAC) system has a temperature sensor enabling accurate measurement of the temperature of the PTC element. The PTC heater for an HVAC system includes a temperature sensor mounted within a PTC rod assembly and placed as close as possible to a PTC element. This enables accurate measurement of the temperature of the PTC element and improves the reliability of the heat generation control logic for preventing overheating of the PTC element.

### CROSS-REFERENCE TO RELATED APPLICATION

This application claims, under 35 U.S.C. § 119(a), the benefit of and priority to Korean Patent Application No. 10-2024-0103865, filed on Aug. 5, 2024, the entire contents of which are incorporated herein by reference.

### TECHNICAL FIELD

The present disclosure relates to a positive temperature coefficient (PTC) heater for a heating, ventilation, and air conditioning (HVAC) system. More particularly, the present disclosure relates to a PTC heater for an HVAC system including a temperature sensor placed as close as possible to a PTC element, enabling accurate measurement of the temperature of the PTC element.

### BACKGROUND

A heating, ventilation, and air conditioning (HVAC) system for a vehicle has a modular structure including an air conditioner case and an evaporator core and heater core mounted within the air conditioner case. The HVAC system is generally mounted within a crash pad constituting a cockpit module.

Generally, the evaporator core for cooling and the heater core for heating are mounted within the air conditioner case. A positive temperature coefficient (PTC) heater for further heating air may be further mounted at a position adjacent to the heater core.

Accordingly, depending on a cooling or heating mode selected by a passenger and a set temperature, air passing through the evaporator core flows into a cabin for cooling, or air passing through the heater core and PTC heater flows into the cabin for heating.

During the heat generating operation of a PTC element mounted inside the PTC heater, a heat generation control logic may be executed. The heat generation control logic includes a process of measuring the temperature of the PTC element by a temperature sensor and a process of restricting generation of heat in the PTC element when the temperature of the PTC element measured by the temperature sensor is greater than or equal to a reference temperature, etc., for preventing overheating of the PTC element.

For reference, the PTC element may be a metal compound that generates heat by power application. The PTC element, also called a PTC stone, may be manufactured in a rectangular block type.

Referring to FIG. 1A, a PTC heater 10 for an HVAC system includes a PTC housing 11, and a plurality of PTC rod assemblies 20 mounted within the housing 11.

Referring to FIG. 1B, in the prior art, a temperature sensor 12, which is a component to execute a heat generation control logic for a PTC element, is mounted in the PTC housing 11. A PTC element 22, the temperature of which is to be measured, is mounted within a thermally conductive tube 23 in the PTC rod assembly 20 mounted within the housing 11.

Because the PTC rod assembly 20 includes a heat dissipation fin 21 surrounding the PTC element 22, the temperature sensor 12 is placed at a position spaced apart from the PTC element 22 by the thickness of the thermally conductive tube 23 and by the length of the heat dissipation fin 21.

Accordingly, the temperature sensor 12 may only indirectly measure the temperature of the PTC element 22. As a result, the measurement accuracy of the temperature sensor 12 for the PTC element 22 is reduced.

To be more specific, because the thermally conductive tube 23, heat dissipation fin 21, etc. are placed between the temperature sensor 12 and the PTC element 22, the temperature of the PTC element measured by the temperature sensor 12 may be different from the actual temperature of the PTC element 22.

Furthermore, as the temperature sensor 12 may not accurately measure the temperature of the PTC element 22, the reliability of the heat generation control logic for preventing overheating of the PTC element 22 may be reduced.

The above information disclosed in this Background section is only to enhance understanding of the background of the present disclosure. Therefore, the Background section may contain information that does not form the prior art that is already known to a person of ordinary skill in the art.

### SUMMARY

The present disclosure has been made in an effort to solve the above-described problems associated with the prior art. The present disclosure provides a positive temperature coefficient (PTC) heater for a heating, ventilation, and air conditioning (HVAC) system including a temperature sensor mounted within a PTC rod assembly and placed as close as possible to a PTC element. This enables accurate measurement of the temperature of the PTC element and improves the reliability of a heat generation control logic for preventing overheating of the PTC element.

In an embodiment, the present disclosure provides a PTC heater for an HVAC system. The PTC heater includes a PTC housing and a plurality of PTC rod assemblies vertically arranged within the PTC housing. The PTC rod assembly has a structure including i) a stone guide having a plurality of stone receiving holes formed therein, ii) PTC elements each inserted into a corresponding one of the stone receiving holes, iii) terminals each tightly attached to a corresponding one of opposite surfaces of the stone guide, and iv) an insulation film attached to the surface of the terminal are inserted into a thermally conductive tube. The PTC heater also includes a printed circuit board having a temperature sensor attached thereto. The temperature sensor is mounted to a side surface portion of the stone guide to measure the temperature of the PTC element.

In an embodiment, the printed circuit board may be mounted to the side surface portion of one or two stone guides of the plurality of PTC rod assemblies.

In another embodiment, the printed circuit board may be a flexible printed circuit board signal-transmissibly connected to a controller. At least two or more of the temperature sensors may be soldered to an internal surface of the flexible printed circuit board at predetermined positions in a vertical lengthwise direction of the flexible printed circuit board.

In still another embodiment, the printed circuit board may be tightly fixed to the side surface portion of the stone guide and the temperature sensor may be inserted to be fastened in the side surface portion of the stone guide.

In yet another embodiment, a lower side position of the stone guide may protrudingly form a first rib to which a lower end portion of the printed circuit board is tightly attached to restrict a vertical movement of the printed circuit board.

In another embodiment, an upper side position of the stone guide may protrudingly form a second rib having a vertically folded shape into which one upper end portion of the printed circuit board is tightly inserted to restrict a left-right movement of the printed circuit board.

In a further embodiment, one upper surface portion of the stone guide may have a guide cover attached thereto having a structure to seal an open portion of the second rib to prevent the printed circuit board inserted in the second rib from being removed.

In another embodiment, a predetermined position at a side surface of the stone guide may form a fastening groove into which the temperature sensor is inserted to be fastened.

In still another embodiment, a vertical lengthwise portion of the printed circuit board adjacent to the terminal may be wrapped by an insulation tape to prevent electrical shorts caused by the printed circuit board being brought into contact with the terminal.

In yet another embodiment, over the side surface portion of the stone guide and the side end portion of the terminal, a side insulation film may be further attached to prevent electrical shorts caused by being brought into contact with the thermally conductive tube.

Other aspects and embodiments of the present disclosure are discussed herein.

It is to be understood that the terms “vehicle” or “vehicular” or other similar terms as used herein are inclusive of motor vehicles in general. Such motor vehicles may encompass passenger automobiles including sport utility vehicles (SUVs), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed herein.

### BRIEF DESCRIPTION OF THE DRAWINGS

The above and other features of the present disclosure are described in detail with reference to certain embodiments thereof illustrated in the accompanying drawings, which are given herein below by way of illustration only, and thus are not limitative of the present disclosure, and wherein:

FIG. 1A is a schematic view illustrating a structure of a positive temperature coefficient (PTC) heater for a heating, ventilation, and air conditioning (HVAC) system of the prior art in which a temperature sensor is mounted;

FIG. 1B is an enlarged cross-sectional view of a portion of a PTC heater for an HVAC system of the prior art where a temperature sensor is mounted;

FIG. 2 is an exploded perspective view illustrating a PTC heater for an HVAC system according to the present disclosure;

FIGS. 3-7 are views orderly illustrating the assembly process of a PTC heater for an HVAC system according to the present disclosure;

FIG. 8 is a plan sectional view of a PTC rod assembly of a PTC heater for an HVAC system according to the present disclosure;

FIG. 9 is a perspective view illustrating a state in which a printed circuit board having a temperature sensor is mounted to a stone guide of a PTC heater for an HVAC system according to the present disclosure:

FIG. 10 is a flow chart of the operation flow and overheating prevention operation of a PTC heater for an HVAC system according to the present disclosure:

FIG. 11 is a front view illustrating an example in which a printed circuit board having a temperature sensor is mounted to two PTC rod assemblies selected from the PTC rod assemblies included in a PTC heater for an HVAC system according to the present disclosure; and

FIG. 12 is a front view illustrating an example in which a printed circuit board having a temperature sensor is mounted to one PTC rod assembly selected from the PTC rod assemblies included in a PTC heater for an HVAC system according to the present disclosure.

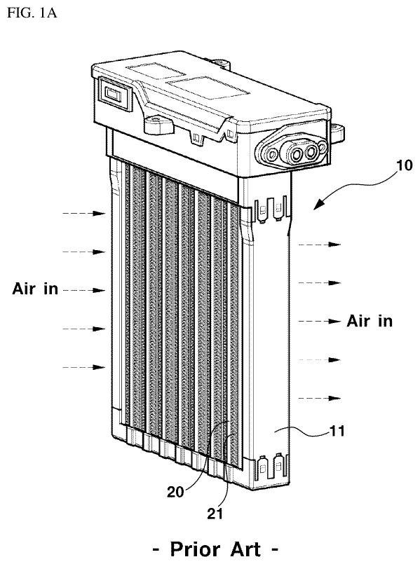

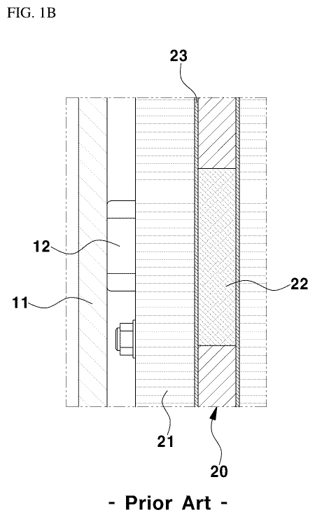

It should be understood that the appended drawings are not necessarily drawn to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the same reference numbers refer to the same or equivalent parts of the present disclosure throughout the several figures of the drawing.

### DETAILED DESCRIPTION

Descriptions of specific structures or functions presented in the embodiments of the present disclosure are merely included for the purpose of explaining the embodiments according to the concepts of the present disclosure. The embodiments according to the concepts of the present disclosure may be implemented in various forms. In addition, the descriptions should not be construed as being limited to the embodiments described herein. Thus, the descriptions and embodiments should be understood to include all modifications, equivalents, and substitutes falling within the idea and scope of the present disclosure.

In this specification, the terms “first”, “second”, etc. may be used to describe various components, but the components are not limited by the terms. These terms are only used to distinguish one component from another. For example, a first component could be termed a second component, and similarly, a second component could be termed a first component, without departing from the scope of embodiments of the present disclosure.

When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Throughout the specification, like reference numerals indicate like components. The terminology used herein is for the purpose of illustrating embodiments and is not intended to limit the present disclosure. In this specification, the singular form includes plural forms unless specified otherwise. The terms “comprise” and/or “comprising” and variations thereof used in this specification mean that the cited component, step, operation, and/or element does not exclude the presence or addition of one or more of other components, steps, operations, and/or elements. The same applies to terms such as “have” and “include” and variations thereof.

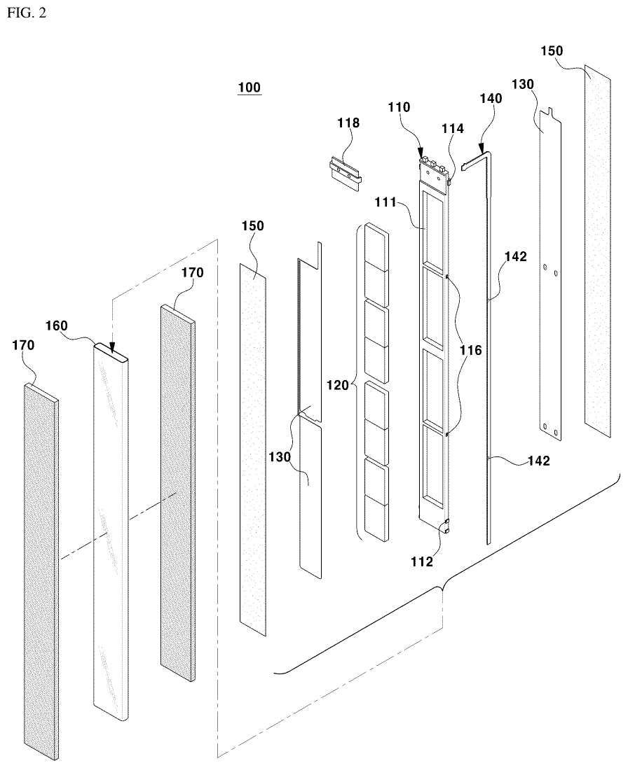

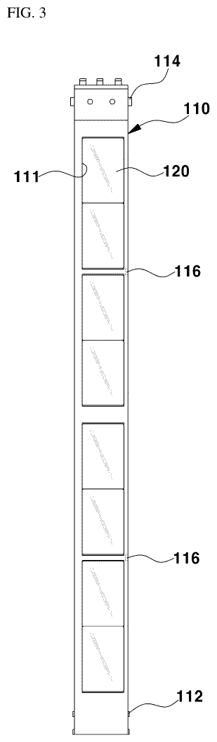

FIG. 2 is an exploded perspective view illustrating a PTC heater for an HVAC system according to the present disclosure. FIGS. 3-7 are views orderly illustrating the assembly process of the PTC heater for an HVAC system according to the present disclosure.

The PTC heater for an HVAC system may include a PTC housing 11 and a plurality of PTC rod assemblies 100 mounted within the PTC housing 11 and arranged at regular intervals.

The present disclosure focuses on accurately measuring the temperature of a PTC element 120 to improve the reliability of a heat generation control logic for preventing overheating of the PTC element 120. This is accomplished by mounting a temperature sensor 142 within the PTC rod assembly 100 and placing the temperature sensor 142 as close as possible to the PTC element 120.

As illustrated in FIG. 2, the PTC rod assembly 100 may have a structure including, i) a stone guide 110 having a plurality of stone receiving holes 111 formed therein, ii) PTC elements 120 each inserted into a corresponding one of the stone receiving holes 111, iii) terminals 130 each tightly attached to a corresponding one of opposite surfaces of the stone guide 110, iv) a printed circuit board 140 having a temperature sensor 142 and mounted to a side surface portion of the stone guide 110, v) insulation films 150 each attached to a corresponding one of the opposite surfaces of the stone guide 110 including the terminals 130, etc. These aspects (i)-(v), etc., are inserted into a thermally conductive tube 160.

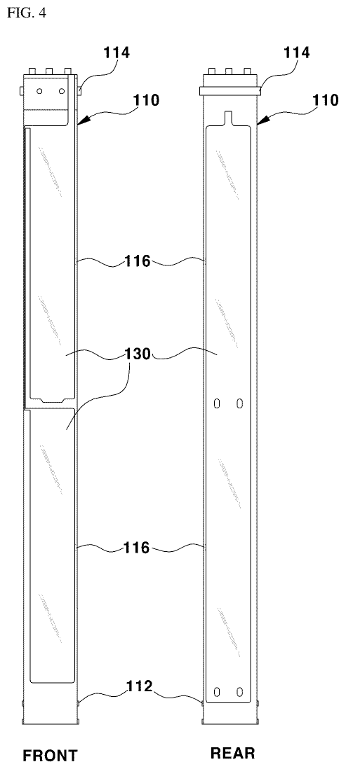

As illustrated in FIG. 3, to assemble the PTC rod assembly 100, first, the PTC elements 120 are inserted into the stone receiving holes 111 in the stone guide 110, respectively. Then, as illustrated in FIG. 4, the terminals 130 making conductive contact with the PTC elements 120 are mounted to the opposite surfaces of the stone guide 110, respectively.

The stone guide 110 is placed in an internal central portion of the PTC rod assembly 100 and has a rectangular frame structure to secure the PTC elements 120. The stone guide 110 has formed therein the stone receiving holes 111 vertically spaced apart from one another into which the PTC elements 120 are inserted, respectively.

Because the receiving hole 111 in the stone guide 110 is formed through a left-right direction, opposite surfaces of the PTC element 120 inserted into each receiving hole 111 are exposed to be brought into contact with the terminals 130 and electrically connected thereto.

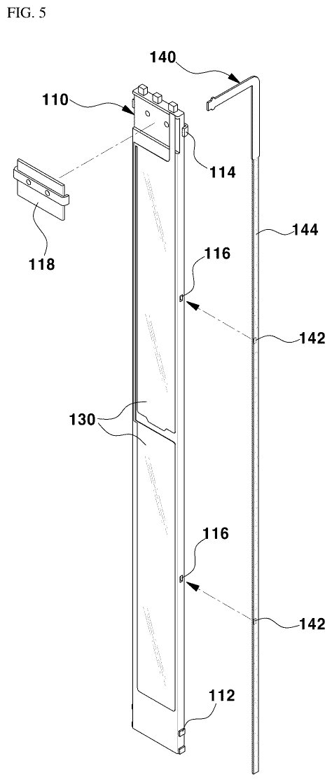

Thereafter, as illustrated in FIG. 5, the printed circuit board 140, to which the temperature sensor 142 is attached, is mounted to the side surface portion of the stone guide 110 to measure the temperature of the PTC element 120.

The printed circuit board 140 may be tightly fixed to the side surface portion of the stone guide 110. At the same time, the temperature sensor 142 may be inserted to be fastened in the side surface portion of the stone guide 110.

In the pre-designed assembly structure of the PTC rod assembly 100, a gap between an internal surface of the thermally conductive tube 160 and a side surface of the stone guide 110 is very narrow (e.g., 0.8 mm). For this reason, the printed circuit board 140 may be a flexible printed circuit board (FPCB) of a very thin circuit film type. At least two or more temperature sensors 142 may be conductively soldered to an internal surface of the printed circuit board 140 at predetermined positions in a vertical lengthwise direction of the flexible printed circuit board.

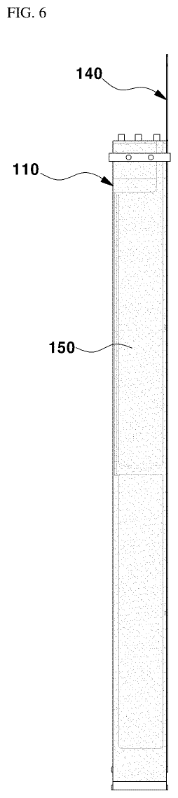

Next, as illustrated in FIG. 6, the insulation films 150 are attached to the opposite surfaces of the stone guide 110 to which the terminals 130 are attached, respectively.

Owing to the insulation film 150, the terminal 130 may be insulated and protected, and electrical shorts, etc. between the terminal 130 and the thermally conductive tube 160 may be prevented.

The insulation film 150 may be an insulation film made of polyimide (PI) material having insulating and heat-resistant properties.

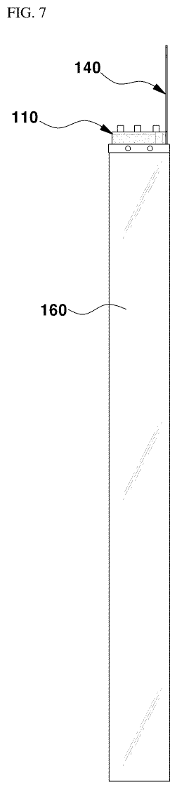

Next, as illustrated in FIG. 7, the stone guide 110 is inserted into the thermally conductive tube 160.

In other words, the stone guide 110, which has i) the PTC elements 120 inserted there into, ii) has the terminals 130 attached thereto, iii) has the printed circuit board 140 mounted thereto (to which the temperature sensors 142 are attached), and iv) has the insulation films 150 attached thereto, is inserted into the thermally conductive tube 160.

The thermally conductive tube 160 may be a flat tube structure made of aluminum material having excellent thermal conductivity.

Finally, a heat dissipation fin 170, which is a type of heat sink, is attached to each of opposite surfaces of the thermally conductive tube 160.

The PTC rod assembly 100 assembled as described above is provided in plurality to be vertically arranged within the PTC housing.

Because the gap between the internal surface of the thermally conductive tube 160 and the side surface of the stone guide 110 is very narrow (e.g., 0.8 mm), when an external force is applied to the thermally conductive tube 160, an electrical short may occur due to unnecessary contact between the internal surface of the thermally conductive tube 160 and the printed circuit board 140 mounted to the side surface of the stone guide 110. An electrical short may also occur due to unnecessary contact between the internal surface of the thermally conductive tube 160 and a side end portion of the terminal 130.

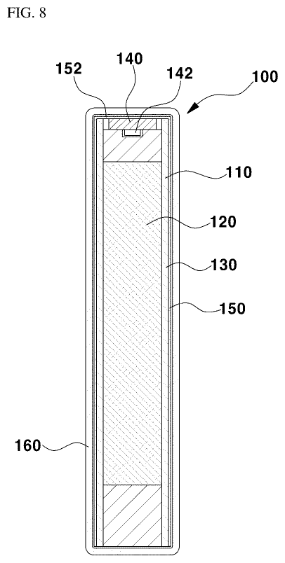

To solve the problem, a side insulation film 152 may further be attached over the side surface portion of the stone guide 110 to prevent electrical shorts caused by being brought into contact with the thermally conductive tube 160, including the printed circuit board 140 and the side end portion of the terminal 130, as illustrated in FIG. 8.

A specific method for mounting the printed circuit board 140 having the temperature sensor 142 to the stone guide 110 is as follows.

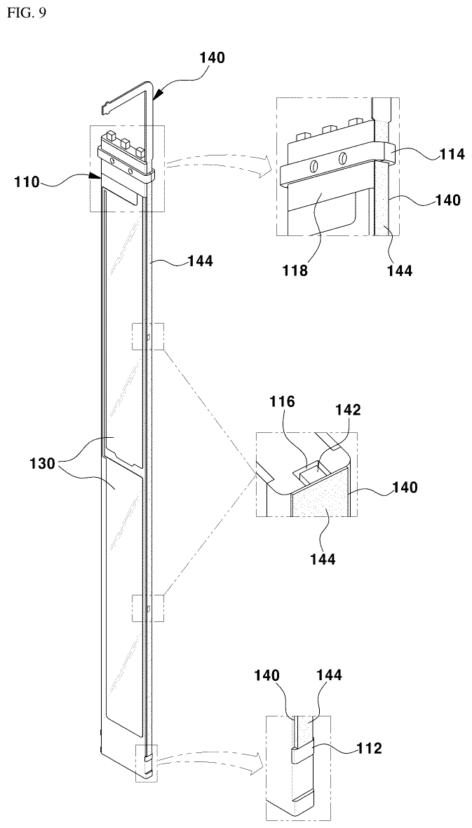

FIG. 9 is a perspective view illustrating a state in which the printed circuit board having the temperature sensor is mounted to the stone guide of the PTC heater for an HVAC system according to the present disclosure.

To tightly fix the printed circuit board 140 to the side surface portion of the stone guide 110 and to insert and fasten the temperature sensor 142 into the side surface portion of the stone guide 110, a first rib 112, a second rib 114, and a fastening groove 116 are formed at the side surface portion of the stone guide 110.

The first rib 112 may integrally protrude from the stone guide 110 at a lower side surface position of the stone guide 110. The second rib 114 may integrally protrude from the stone guide 110 in a vertically folded shape at an upper side surface portion of the stone guide 110. The fastening groove 116 may be formed to be concave in the side surface portion of the stone guide 110 at a position where the temperature sensor 142 is inserted to be fastened.

With this structure, as illustrated in FIG. 9, when the printed circuit board 140 is pressed against the side surface portion of the stone guide 110, a lower end portion of the printed circuit board 140 is tightly brought into contact with the first rib 112 to thereby restrict a vertical movement of the printed circuit board 140. At the same time, one upper end portion of the printed circuit board 140 is tightly inserted into the second rib 114 having a vertically folded shape to thereby restrict a left-right movement of the printed circuit board 140.

Particularly, when the printed circuit board 140 is pressed against the side surface portion of the stone guide 110, the temperature sensor 142 attached to the internal surface of the printed circuit board 140 is inserted to be seated in the fastening groove 116 in the stone guide 110, as illustrated in FIG. 9, placing the temperature sensor 142 as close as possible to the PTC element 120 with a side wall of the stone guide 110 there between.

Moreover, as illustrated in FIG. 9, a guide cover 118, having a structure to seal the open portion of the second rib 114, is attached to one upper surface portion of the stone guide 110. Thus, the printed circuit board 140 inserted in the second rib 114 is easily prevented from deviating from its position.

By mounting, within the PTC rod assembly, the printed circuit board 140, having attached thereto the temperature sensor 142, to the side portion of the stone guide 110 accommodating therein the PTC element 120 to thereby place the temperature sensor 142 as close as possible to the PTC element 120, the temperature sensor 142 may accurately measure the temperature of the PTC element 120 when the PTC element 120 generates heat.

By wrapping an insulation tape 144 around a vertical lengthwise portion of the printed circuit board 140 adjacent to the terminal, electrical shorts caused by unnecessary contact between the printed circuit board 140 and the terminal 130 may be easily prevented.

Hereinafter, the heating operation flow and overheating prevention operation of the PTC heater for an HVAC system of the present disclosure having the above structure are described.

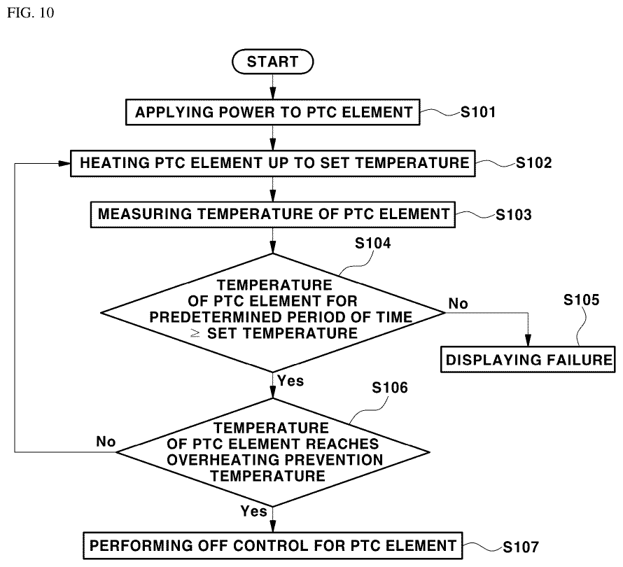

FIG. 10 is a flow chart of the operation flow and overheating prevention operation of the PTC heater for an HVAC system according to the present disclosure.

First, power is applied to the PTC element 120 through the terminal 130 by a duty control signal of a controller (not shown) to operate the PTC heater, at step S101.

Next, by the application of power to the PTC element 120, the PTC element 120 generates heat to reach a set temperature corresponding to a heater operation stage, at step S102.

Thereafter, the temperature sensor 142 measures the temperature of the PTC element 120, at step S103.

As described above, because the temperature sensor 142 is inserted to be seated in the fastening groove 116 in the stone guide 110 and positioned as close as possible to the PTC element 120 with the side wall of the stone guide 110 there between, the temperature sensor 142 may accurately measure the temperature of the PTC element 120 when the PTC element 120 generates heat.

The temperature sensor 142 that has measured the temperature of the PTC element 120 transmits a measurement signal to the controller (not shown) through the printed circuit board 140, allowing the controller to recognize the temperature of the PTC element 120.

Thereafter, based on the measurement signal from the temperature sensor 142, the controller determines whether the temperature of the PTC element 120 reaches or maintains the set temperature for a predetermined period of time, at step S104.

When the controller determines that the temperature of the PTC element 120 does not reach or maintain the set temperature for a predetermined period of time (NO at step 104), the controller recognizes it as a failure of the PTC element 120 and displays an indication on a display in a vehicle that the PTC heater is faulty, at step S105.

Conversely, when the temperature of the PTC element 120 reaches or maintains the set temperature for a predetermined period of time (YES at step 104), the controller may recognize that the PTC heater is operating normally.

During the normal operation of the PTC heater, the controller determines whether the temperature of the PTC element 120 has reached an overheating prevention temperature (e.g., 150° C.) based on the measurement signal received from the temperature sensor 142, at step S106.

When the controller determines that the temperature of the PTC element 120 has reached the overheating prevention temperature (YES at step 106), the controller performs OFF control to cut off power to the PTC element 120, at step S107.

As the temperature sensor 142 accurately measures the temperature of the PTC element 120, the controller may receive the accurate measurement signal of the temperature sensor 142 through the printed circuit board 140, improving the reliability of the heat generation control logic of the controller that cuts off power to the PTC element 120 to prevent overheating of the PTC element 120.

The printed circuit board 140 to which the temperature sensor 142 is attached may be mounted to the side surface portion of one or two stone guides 110 of the plurality of PTC rod assemblies 100.

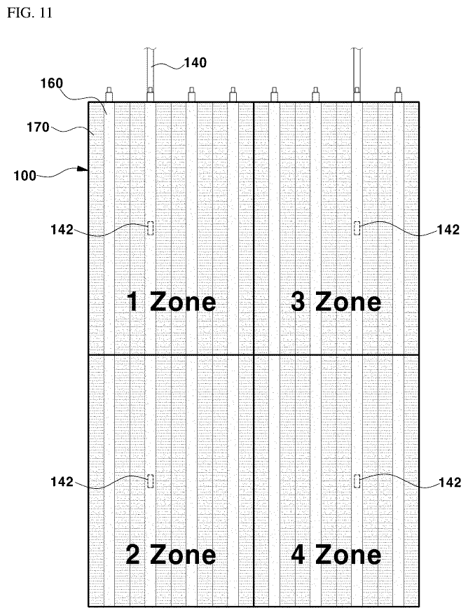

For example, by mounting, as illustrated in FIG. 11, the printed circuit board 140, to which two temperature sensors 142 are attached to the side surface portion of the stone guide 110 of two PTC rod assemblies 100 selected from the plurality of PTC rod assemblies 100 included in the PTC heater for an HVAC system, even when the entire area of the PTC heater is divided into four equal portions (zones 1 to 4), each temperature sensor 142 may measure the representative temperature of the PTC element 120 included in each zone 1 to 4. This reduces the number of components, such as a temperature sensor and printed circuit board, and costs.

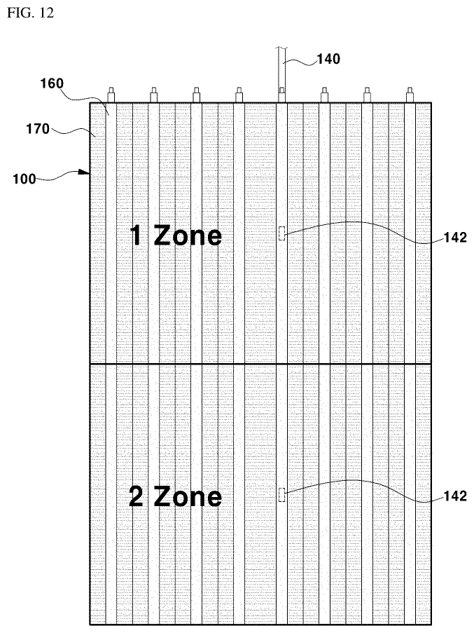

Or, as illustrated in FIG. 12, by mounting the printed circuit board 140, to which two temperature sensors 142 are attached to the side surface portion of the stone guide 110 of one PTC rod assembly 100 selected from the plurality of PTC rod assemblies 100 included in the PTC heater for an HVAC system, even when the entire area of the PTC heater is divided into two equal portions (zones 1 and 2), each temperature sensor 142 may measure the representative temperature of the PTC element 120 included in zones 1 and 2. Similarly to above, this reduces the number of components, such as a temperature sensor and printed circuit board, and costs.

As should be apparent from the above description, the present disclosure provides the following effects.

First, by mounting, within the PTC rod assembly 100, the flexible printed circuit board 140 having the temperature sensor 142 attached thereto to the side surface portion of the stone guide 110 accommodating therein the PTC element 120 to thereby place the temperature sensor 142 as close as possible to the PTC element 120, the temperature sensor 142 may accurately measure the temperature of the PTC element 120 when the PTC element 120 generates heat.

Second, as the temperature sensor 142 accurately measures the temperature of the PTC element 120, the controller may receive an accurate measurement signal from the temperature sensor 142 through the printed circuit board 140. This improves the reliability of the heat generation control logic of the controller to prevent overheating of the PTC element 120.

Although the present disclosure has been described in detail with reference to certain embodiments, the scope of the present disclosure is not limited to the above-described embodiments. Various modifications and improvements by those of ordinary skill in the art based on the basic concepts of the present disclosure as defined in the claims below should also be included in the scope of the present disclosure.

What is claimed is:

1. A positive temperature coefficient (PTC) heater for a heating, ventilation, and air conditioning (HVAC) system, the PTC heater comprising:
a PTC housing;
a plurality of PTC rod assemblies vertically arranged within the PTC housing, wherein the PTC rod assembly has a structure in which i) a stone guide having a plurality of stone receiving holes formed therein, ii) PTC elements each inserted into a corresponding one of the stone receiving holes, iii) terminals each tightly attached to a corresponding one of opposite surfaces of the stone guide, and iv) an insulation film attached to the surface of the terminal are inserted into a thermally conductive tube; and
a printed circuit board having a temperature sensor attached thereto, wherein the temperature sensor is mounted to a side surface portion of the stone guide to measure a temperature of the PTC element.

2. The PTC heater of claim 1, wherein the printed circuit board is mounted to the side surface portion of one or two stone guides of the plurality of PTC rod assemblies.

3. The PTC heater of claim 1, wherein the printed circuit board is a flexible printed circuit board, and wherein at least two or more of the temperature sensors are soldered to an internal surface of the flexible printed circuit board at predetermined positions in a vertical lengthwise direction of the flexible printed circuit board.

4. The PTC heater of claim 1, wherein the printed circuit board is tightly fixed to the side surface portion of the stone guide, and wherein the temperature sensor is inserted to be fastened in the side surface portion of the stone guide.

5. The PTC heater of claim 4, wherein a lower side position of the stone guide forms a first rib to which a lower end portion of the printed circuit board is tightly attached to restrict a vertical movement of the printed circuit board.

6. The PTC heater of claim 4, wherein an upper side position of the stone guide forms a second rib having a vertically folded shape into which one upper end portion of the printed circuit board is tightly inserted to restrict a left-right movement of the printed circuit board.

7. The PTC heater of claim 4, wherein one upper surface portion of the stone guide has a guide cover attached thereto having a structure to seal an open portion of the second rib to prevent the printed circuit board inserted in the second rib from being removed.

8. The PTC heater of claim 1, wherein a fastening groove is disposed at a predetermined position at a side surface of the stone guide, and wherein the temperature sensor is inserted to be fastened in the fastening groove.

9. The PTC heater of claim 1, wherein a vertical lengthwise portion of the printed circuit board adjacent to the terminal is wrapped by an insulation tape to prevent electrical shorts caused by the printed circuit board being brought into contact with the terminal.

10. The PTC heater of claim 1. wherein a side insulation film is attached over the side surface portion of the stone guide and a side end portion of the terminal to prevent electrical shorts caused by being brought into contact with the thermally conductive tube.
